(19) United States
(12) Patent Application Publication
(10) Pub. No.: US 2005/0044033 A1
(43) Pub. Date: Feb. 24, 2005

(54) Like-kind exchange method

(76) Inventors: Andrew F. Gelson, Forestdale, MA (US); Edwin Rivera, Hanover, MA (US); Edward L. Glazer, Natick, MA (US); David Marcus, West Newton, MA (US)

Correspondence Address: DICKSTEIN SHAPIRO MORIN & OSHINSKY LLP;Michael J. Scheer, 41st Floor, 1177 Avenue of the Americas, New York, NY, 10036-2714, US

(21) Appl. No.: 10/754,700

(22) Filed: Jan. 12, 2004

Related U.S. Application Data
(60) Provisional application No. 60/439,125, filed on Jan. 10, 2003.

(51) Int. Cl. G06F 17/60

(52) U.S. Cl. 705/37; 705/42

(57) ABSTRACT

A like-kind exchange method wherein an accommodator acquires a property on behalf of an exchanger and establishes itself as the tax owner of the acquired property by becoming liable to pay on at least a portion of a debt on the acquired property. The accommodator then leases the acquired property to the exchanger with an option to buy. During the term of the lease, the exchanger is free to perform any desired development work on the acquired property. With this procedure, the acquired property is available as a replacement property in a like-kind exchange by the exchanger for longer than the 180 day time limitation imposed by Revenue Procedure 2000-37.

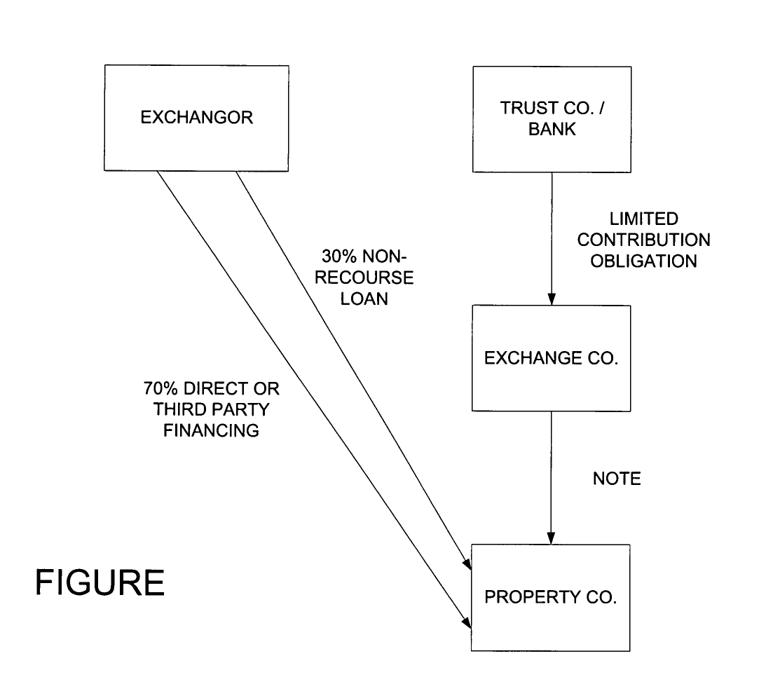

### CROSS REFERENCE TO RELATED APPLICATIONS

The present application is based on and claims priority to U.S. Provisional application No. 60/439,125, filed Jan. 10, 2003, the entirety of which is incorporated herein by reference.

### BACKGROUND OF THE INVENTION

1. Field of the Invention

The present invention relates to a method for like-kind exchanges.

2. Description of the Related Art

Like-kind exchange strategies are vital components of capital recycling programs in place at most real estate investment trusts (REIT's) and real estate operating companies (REOC's). Such strategies need to be structured to reflect the fact that many real property owners have land development programs that require one to three years for a property to be acquired, zoned, approved, pre-leased, and developed.

Section 1031 of the Internal Revenue Code expressly provides for the deferred recognition of gain in a like-kind exchange. Under that section, a taxpayer (“Exchanger”) may defer recognizing the taxable gain realized on the divestiture of business or income producing property (e.g., property held for productive use in trade or business or held for investment) by exchanging that property for other business or income producing property of like-kind. By completing such an exchange, the Exchanger may dispose of its business or investment property, use all of its equity to acquire replacement business or investment property, and defer the tax that would ordinarily be paid.

Like-kind exchanges are structured so that the Exchanger receives like-kind replacement property and that the amount of cash or non-like-kind property that Exchanger receives is reduced to a minimum. Provided the Exchanger receives like-kind property with equal or greater value and equal or greater equity, it will defer recognition of gain. To the extent that the Exchanger receives cash or non like-kind property, it will recognize gain on the exchange.

The various structures that could be used to facilitate like-kind exchanges are discussed below.

Simultaneous Exchange:

The simplest structure would be for the Exchanger to effect a simultaneous exchange of the relinquished property for replacement property with a single counterparty. However, finding a single counterparty, who wanted to both acquire the property that the Exchanger wished to relinquish and to divest itself of the property that the Exchanger wished to acquire, would be highly unlikely.

Instead, the vast majority of like-kind exchanges involve a separate buyer and seller and are effected with the assistance of an intermediary (“Qualified Intermediary”) as described in detail below.

Forward Exchange:

U.S. Department of Treasury regulations adopted in 1991 expressly authorized Forward Exchanges through a Qualified Intermediary. In a Forward Exchange, the divestiture of the relinquished property takes place first. Under an Exchange Agreement, the Exchanger assigns its rights in the contract of sale of the relinquished property to the Qualified Intermediary. The cash or other proceeds from the relinquished property are received by the Qualified Intermediary and held in a separate, secure account. An important limitation is that the Exchanger cannot have any right to receive, pledge, borrow or otherwise benefit from the funds held by the Qualified Intermediary until the exchange period ends. The Exchanger then identifies a limited number of eligible replacement properties within 45 days, and within 180 days of the sale, such proceeds are used by the Qualified Intermediary to acquire the replacement property. Typically the Qualified Intermediary receives an assignment of rights to the contract of sale for the replacement property and causes such replacement property to be transferred directly to the Exchanger.

The regulations did not provide for an exchange in which the Exchanger (directly or through the involvement of a Qualified Intermediary) acquires replacement property before disposing of the its relinquished property (a so-called “Reverse Exchange” or “Parking Arrangement”).

Reverse Exchange:

Revenue Procedure 2000-37 established a safe harbor for “reverse 1031” or “Parking Arrangements.” In a Reverse Exchange, the acquisition of replacement property takes place prior to the Exchanger's divestiture of the property to be relinquished. Generally, an Exchanger seeking to complete a reverse exchange may not directly take title to the replacement property before the relinquished property is sold (a so called “pure-reverse”). Instead, the Exchanger must arrange for a third party, called an Exchange Accommodation Titleholder (EAT), to hold legal title to the replacement property until the Exchanger is prepared to dispose of the relinquished property and receive the replacement property to complete the exchange. A substantial limitation on the usefulness of Revenue Procedure 2000-37 is the requirement that the replacement property be transferred to the Exchanger within 180 days of its transfer to the EAT.

Although Revenue Procedure 2000-37 improves an Exchanger's ability to complete like-kind exchanges, many Exchangers find it difficult to complete their exchanges within the required 180 day time period. Companies involved in the development of real estate from the ground up, for example, are particularly affected by these timing constraints.

Accordingly, there is a need for a like-kind exchange method which extends the 180 deadline created by Revenue Procedure 2000-37.

### SUMMARY OF THE INVENTION

In accordance with preferred embodiments of the like-kind exchange method of the present invention, an accommodator first acquires a property on behalf of an exchanger. The accommodator establishes itself as the tax owner of the acquired property by becoming liable to pay at least a portion of a debt on the acquired property. The accommodator then leases the acquired property to the exchanger providing the exchanger with an option to buy. In the preferred embodiment, the replacement property is improved before the exchanger acquires it, enabling the acquired property, including the improvements, to be available as replacement property in the like-kind exchange.

In the preferred embodiment, the accommodator acquires ownership of the replacement property through a property owning entity (“Property Co.”) with funding equal to approximately seventy percent of the value of the project provided or arranged by the exchanger (the “senior debt”). This financing could come from a trust company or a bank. The exchanger also would arrange or provide subordinate financing to Property Co. in an amount equal to approximately thirty percent for all other costs of the project, including planned enhancements to the replacement property. Neither the trust company (or bank), the accommodator, Property Co., nor their affiliates, would provide the subordinated financing.

In order to establish an appropriate level of risk capital intended to qualify Property Co. as the tax owner, Property Co. is preferably capitalized by a promissory note from the accommodator preferably equal to 5% to 10% of the project cost. The accommodator preferably also guarantees a percentage of the senior debt. The exchanger, in providing the subordinate loan, cannot collect on the promissory note from the accommodator. The exchanger's only collateral for the subordinate note is the property owned by Property Co.

Upon acquisition of the replacement property, Property Co. leases the property to the exchanger. Specifically, the lease preferably obligates the exchanger to (1) complete any improvements to the replacement property, (2) perform all property management functions, (3) pay all operating costs associated with the property, (4) make lease payments that would fully amortize the financing over the term of the lease, and (5) provide appropriate indemnification to Property Co. The lease also grants to the exchanger a right to purchase the property. The purchase option is intended to be sufficient to repay all debt, and costs incurred by the accommodator plus a profit.

As noted above, Property Co.'s at risk position is reduced by the subordinate debt provided by the exchanger in an amount equal to approximately 30% of total project costs. Because the exchanger's only source of repayment for the subordinate loan is the replacement property, the exchanger or other subordinate lender bears the first risk of loss up to the full amount of its thirty percent subordinated debt.

Accordingly, with the present invention, Property Co. and accommodator act on their own behalf and an agency relationship is not established with the exchanger. Accordingly, there is no limit on the amount of time the accommodator or Property Co. can own the property. The above procedure enables the accommodator to be treated as a tax owner under federal income tax principles while not being considered the owner for generally accepted accounting principles, and while not advancing its own funds to acquire or develop the property.

The like-kind exchange method of the present invention thus provides a conservative and cost effective way to park properties for longer than the 180 day time period imposed by Revenue Procedure 2000-37. The present invention also enables real estate owners to complete their exchanges and save taxes.

### BRIEF DESCRIPTION OF THE DRAWING

For the purposes of illustrating the present invention, there is shown in the FIGURE a form which is presently preferred, it being understood however, that the invention is not limited to the precise form shown.

### DETAILED DESCRIPTION OF THE INVENTION

The following detailed description is based upon the present invention being used for the like-kind exchange of real estate under Section 1031 of the Internal Revenue Code. It will be readily apparent from the following detailed description, however, that the same methodology could be used to effectuate a like-kind exchange of any personal property, real or personal, tangible and intangible.

Referring now to the FIGURE, a like-kind exchange according to the present invention is first initiated when a party (hereinafter referred to as an “exchanger”) identifies to an accommodator (hereinafter referred to as “Exchange Co.) real property (hereinafter the “project”) which the exchanger wishes to develop and utilize in a like-kind exchange. In most instances, the exchanger will be some type of corporate entity (such as a limited liability company) or a partnership. It is possible, however, that the exchanger is an individual.

Exchange Co. is a company that is established to facilitate the like-kind exchanges of real and personal property under Section 1031.

Exchange Co. is preferably funded by a limited contribution obligation from a third party. The third party may be a trust company or a bank. This contribution is preferably used as the basis for calculating the amount of any project that Exchange Co. may become involved. In the most preferred embodiment, Exchange Co. has no other source of funds other than the contribution obligation and fee, lease and option payments for facilitating this and other like-kind transactions. The fee, lease and option payments will be described in further detail below.

Next, Exchange Co. preferably establishes a property owning entity (hereinafter referred to as “Property Co.”) to acquire the property. Preferably, Property Co. is a Limited Liability Company (LLC), and Exchange Co. is the sole member. Alternatively, Property Co. is a nominee trust of which Exchange Co. is the sole beneficiary. Ownership to either the relinquished and/or replacement property is vested in Property Co. to insulate Exchange Co. from liability and help facilitate the transfer of like-kind property in exchange for relinquished property. This parking arrangement permits improvements to be made to the replacement property so as to increase its value, thereby enabling the exchanger to defer the recognition of taxable gain on the disposition of the relinquished property.

Property Co. is preferably capitalized through the contribution by Exchange Co of a promissory note in an amount appropriate for the transaction, depending on the value of the project and the planned improvements thereon.

In acquiring the replacement property, Property Co. acquires a real estate interest in the replacement property. Preferably, Property Co. acquires a fee simple ownership. Alternatively, Property Co. may acquire a long term ground lease or thirty years or more. After the replacement property is acquired by Property Co., the exchanger preferably assigns all construction and development contracts relating to the project to Property Co.

Upon the conveyance of the interest in the project to Property Co. and the assignment of contracts described above, the exchanger provides a loan to Property Co. in an amount preferably equal to the difference between the anticipated cost of the construction and development of the project (including construction period interest and taxes) and the amount of construction financing to be obtained for the project. The difference is preferably approximately 30% of the estimated construction and development costs for the project. The loan is also preferably set up to be a non-recourse loan to any assets of Property Co. other than the project, and is subordinate to any third party financing (including the construction financing).

After the funding of the loan and the fulfillment of any other lender conditions (including pre-leasing), Property Co. obtains third party construction financing in an amount preferably equal to the remaining approximate 70% of the estimated cost of the construction and development of the project. Preferably, the third party construction financing is obtained by the exchanger or its affiliate. As stated above, Exchange Co. provides a partial guaranty to the construction financing lender(s) in an amount preferably equal to a percentage aggregate principal amount of the construction financing. The amount of the guarantee can range from, for example, 2% to 10% of the aggregate principal amount of the construction financing. Other percentages can be established depending upon the value of the construction financing and the amount of risk that Property Co. is willing to take in the project, and the economic reward the exchanger is willing to pay Exchange Co. to take such risk. Any amounts paid by Exchange Co. with respect to the guaranty of the construction financing will, however, reduce dollar-for-dollar the principal obligation of Exchange Co. under the promissory note used to fund Property Co.

After Property Co. obtains the construction financing, Property Co. leases the project to the exchanger pursuant to an operating lease on arms-length terms sufficient to pay the debt service on the project, with a purchase option (described in greater detail below). The exchanger or an affiliate is engaged as a construction manager, and is thereafter responsible for overseeing all development, construction and operations of the project on behalf of Property Co. pursuant to the operating lease and any related development or management agreements.

Any development or other project ownership risks are allocated under the operating lease to the exchanger. All such risks are allocated by means of representations and warranties by the exchanger covering zoning, land use, environmental damage and similar risks. Pursuant to the operating lease, the exchanger will also have a contractual completion obligation (preferably at the exchanger's expense) with respect to the construction and development of the project. Such completion obligation is preferably structured as representations and warranties with respect to the project.

Pursuant to the operating lease, the exchanger pays rent to Property Co. The rent amount is structured to meet all operating costs, including debt service, and provide Property Co. with a profit equal to, for example, approximately 3% of Property Co.'s at-risk amounts, based on Property Co.'s projected operating costs and income. The rent amount can, however, be adjusted to be greater or less than 3% depending upon the exchanger's requirements and level of risk that the exchanger wishes Property Co. to assume.

Preferably, the exchanger commences and oversees management of project operations in, and causes the lease-up of the completed stages of the project.

With the above arrangement, Exchange Co. and Property Co. specifically disavow any agency relationship with the exchanger in any instrument relating to the transactions described above.

As stated above, the exchanger has a fixed-term purchase option which can be exercised to purchase all (but not less than all) of the interests in Property Co. and thus acquire full interests in the project. Exercise of the purchase option is designed to be subject to payment by the exchanger of an exercise fee to Exchange Co. that will produce a further profit to Exchange Co. Under the operating lease, Exchange Co. will not have any put rights with respect to its interests in Property Co.

The purchase price for the interests in Property Co. is preferably on a sliding scale and is in an amount calculated to equal costs incurred by Exchange Co., plus a reasonable profit by Exchange Co. (preferably approximately 2-10% on its at-risk amounts on an overall basis, taking into account its projected profits under the operating lease).

The exercise of the purchase option by the exchanger is preferably timed to the sale of exchanger's relinquished property. Preferably, consideration is given to coordinate the exercise of the purchase option with the maturity date of the construction financing.

In the event that the exchanger does not exercise the purchase option, Property Co. could sell the property to a third party. The value and marketability of the property is supported by the rent stream under the lease which services and amortizes all the financing and which, in turn, is supported by the credit of the exchanger.

Accordingly, with the present invention, Property Co. and Exchange Co. act on their own behalf and an agency relationship is not established with the exchanger. Accordingly, there is no limit on the amount of time Property Co. or Exchange Co. can own the property. The above procedure also enables Property Co. or Exchange Co. to be treated as a tax owner under federal income tax principles while not being treated as the owner under generally accepted accounting principles, and without having to invest any cash toward the acquisition of the project.

The like-kind exchange method of the present invention thus provides a conservative and cost effective way to park properties for longer than the 180 day time period imposed by Revenue Procedure 2000-37. The present invention also enables real estate owners to complete their exchanges and save taxes.

Although the present invention has been described in relation to particular embodiments thereof, many other variations and other uses will be apparent to those skilled in the art. It is preferred, therefore, that the present invention be limited not by the specific disclosure herein, but only by the scope of the claims.

1. A like-kind exchange method comprising:
establishing an accommodating entity to facilitate the like-kind exchange, the accommodating entity being funded by a limited contribution obligation from a third party;
receiving a request from an exchanger that identifies a replacement property to utilize in the like-kind exchange;
establishing a property owning entity to acquire an ownership interest in the replacement property, the property owning entity being capitalized through a contribution by the accommodating entity of a promissory note in an amount appropriate for the like-kind exchange; and
exchanging a relinquished property of the exchanger with the replacement property.

2. The like-kind exchange method according to claim 1, wherein the exchanger is a corporate entity.

3. The like-kind exchange method according to claim 1, wherein the exchanger is one of a partnership and a limited liability company.

4. The like-kind exchange method according to claim 1, wherein the exchanger is an individual.

5. The like-kind exchange method according to claim 1, wherein the third party is one of a trust company and a bank.

6. The like-kind exchange method according to claim 1, wherein the property owning entity is a limited liability company of which the accommodating entity is a sole member.

7. The like-kind exchange method according to claim 1, wherein the property owning entity is a nominee trust of which the accommodating entity is a sole beneficiary.

8. The like-kind exchange method according to claim 1, the method further comprising insulating the accommodating entity from liability and facilitating a transfer of the replacement property in exchange for the relinquished property in the like-kind exchange by vesting ownership of the replacement property in the property owning entity.

9. The like-kind exchange method according to claim 1, the method further comprising making improvements to the replacement property to increase its value.

10. The like-kind exchange method according to claim 9, wherein an amount of the limited contribution obligation is related to a cost of the initial acquisition of the replacement property and a cost of the improvements.

11. The like-kind exchange method according to claim 10, wherein the amount of the limited contribution obligation is 5% of the cost of the initial acquisition of the replacement property and the cost of the improvements.

12. The like-kind exchange method according to claim 1, wherein the property owning entity acquires a fee simple ownership in the replacement property.

13. The like-kind exchange method according to claim 1, wherein the property owning entity acquires a ground lease in the replacement property.

14. The like-kind exchange method according to claim 1, the method further comprising the exchanger assigning construction and development contracts relating to the replacement property to the property owning entity.

15. The like-kind exchange method according to claim 1, wherein the property owning entity obtains financing for the acquisition and improvement of the replacement property.

16. The like-kind exchange method according to claim 15, wherein the financing includes a first loan from the exchanger.

17. The like-kind exchange method according to claim 16, wherein the first loan is non-recourse.

18. The like-kind exchange method according to claim 16, wherein the first loan is approximately 30% of the anticipated cost of construction and development of the replacement property.

19. The like-kind exchange method according to claim 16, wherein the financing further includes a second loan.

20. The like-kind exchange method according to claim 19, wherein the second loan is from the exchanger.

21. The like-kind exchange method according to claim 19, wherein the second loan is from a fourth party.

22. The like-kind exchange method according to claim 19, wherein at least a portion of the second loan is recourse.

23. The like-kind exchange method according to claim 22, wherein the portion ranges from 2% to 10% of the second loan.

24. The like-kind exchange method according to claim 19, wherein any amount paid by the accommodating entity with respect to the second loan reduces a principal obligation of the accommodating entity under the promissory note used to capitalize the property owning entity.

25. The like-kind exchange method according to claim 1, the method further comprising the property owning entity leasing the replacement property to the exchanger with a purchase option pursuant to an operating lease on arms-length terms sufficient to pay a debt service on the replacement property.

26. The like-kind exchange method according to claim 25, the method further comprising structuring the lease to meet all operating costs, including debt service, and provide the property owning entity with a profit equal to a percentage of an at-risk amount of the property owning entity.

27. The like-kind exchange method according to claim 25, wherein exercise of the purchase option subjects the exchanger to payment of an exercise fee.

28. The like-kind exchange method according to claim 25, wherein the accommodating entity does not have any put rights under the lease with respect to its interests in the property owning entity.

29. The like-kind exchange method according to claim 1, wherein the accommodating entity and the property owning entity specifically disavow any agency relationship with the exchanger.

30. A like-king exchange method comprising:
establishing an accommodating entity to facilitate the like-kind exchange, the accommodating entity being funded by a limited contribution obligation from a third party;
receiving a request from an exchanger that identifies a replacement property to utilize in the like-kind exchange;
establishing a property owning entity to acquire an ownership interest in the replacement property, the property owning entity being capitalized through a contribution by the accommodating entity of a promissory note in an amount appropriate for the like-kind exchange;
the property owning entity obtaining financing for the acquisition and improvement of the replacement property;
the property owning entity leasing the replacement property to the exchanger with a purchase option pursuant to an operating lease on arms-length terms sufficient to pay a debt service on the replacement property; and
exchanging a relinquished property of the exchanger with the replacement property.

30. A structure for facilitating a like-kind exchange, the structure comprising:
an exchanger that identifies a replacement property to utilize in the like-kind exchange;
an accommodating entity that facilitates the like-kind exchange;
a third party that funds the accommodating entity by a limited contribution obligation; and
a property owning entity that acquires an ownership interest in the replacement property, the property owning entity being capitalized through a contribution by the accommodating entity of a promissory note in an amount appropriate for the like-kind exchange.
